(19) United States
(12) Patent Application Publication
(10) Pub. No.: US 2011/0154936 A1
(43) Pub. Date: Jun. 30, 2011

(54) PARALLEL ROBOT

(75) Inventors: ZHI-MING ZHAO, Shenzhen City (CN); GUO-QING ZHANG, Shenzhen City (CN); XIAO-BIN WU, Shenzhen City (CN); CHIA-PENG DAY, Santa Clara, CA (US)

(73) Assignees: HONG FU JIN PRECISION INDUSTRY (ShenZhen) CO., LTD ., Shenzhen City (TW); HON HAI PRECISION INDUSTRY CO., LTD., Tu-Cheng (TW)

(21) Appl. No.: 12/910,997

(22) Filed: Oct. 25, 2010

(30) Foreign Application Priority Data
Dec. 29, 2009 (CN) 200910312513.5

(51) Int. Cl. B25J 18/00

(52) U.S. Cl. 74/490.04

(57) ABSTRACT

A parallel robot includes a base, a movable platform, a first kinematic chain and a second kinematic chain. The first and the second kinematic chains are connected to the fixed platform and the movable platform respectively, and move on the same plane. Each of the first and second kinematic chains includes a linear driving mechanism mounted on the base and a parallel four-bar linkage driven by the linear driving mechanism and hinged on the movable platform.

### BACKGROUND

1. Technical Field

The present disclosure generally relates to robot technologies, and particularly, to a parallel robot.

2. Description of Related Art

Parallel robots have advantages of stability, load-bearing capability, favorable weight to load ratio, and dynamic characteristics among other things, and thus can be used in many fields.

A commonly used parallel robot includes a base, a movable platform, and six control arms with two ends pivotally connecting the movable platform and the base, respectively. Each control arm includes an actuator and a movable member driven by the actuator. When the movable members are cooperatively moved by the corresponding actuators, the movable platform can be moved to a predetermined position to realize six-freedom displacement. However, the typically used parallel robot has a relatively complex construction and control system, making it difficult to control and maintain.

Therefore, a parallel robot is desired that can overcome the described limitations.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout several views.

FIG. 1 is an isometric, assembled view of one embodiment of a parallel robot.

FIG. 2 is an exploded, isometric view of the parallel robot of FIG. 1.

FIG. 3 is an exploded, isometric view of part of the parallel robot of FIG. 1.

FIG. 4 is a front view of the parallel robot of FIG. 1 in an operating state.

### DETAILED DESCRIPTION

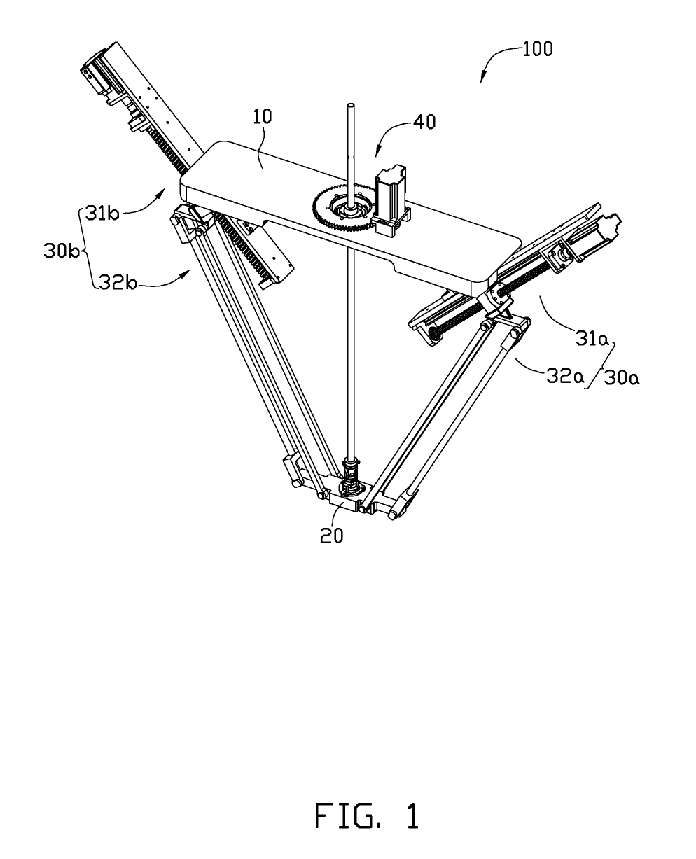

Referring to FIG. 1, an embodiment of a parallel robot 100 includes a base 10, a movable platform 20, a first kinematic chain 30a, a second kinematic chain 30b, and a third kinematic chain 40. An end effector, such as a gripper, or a cutting tool, is mounted at a distal end of the kinematic chain 40 and rotatable relative to the movable platform 20. The first and the second kinematic chains 30a, 30b connect the base 10 and the movable platform 20, respectively, and move in the same plane. The third kinematic chain 40 moves together with the movable platform 20, and rotates the end effector relative to the movable platform 20, so that the end effector can realize three degrees of freedom (two degrees of movement and one degree of rotation).

In this illustrated embodiment, the first and second kinematic chains 30a, 30b have similar structures and are substantially bilaterally symmetric. The first kinematic chain 30a includes a linear driving mechanism 31a mounted on the base 10, and a parallel four-bar linkage 32a driven by the linear driving mechanism 31a and hinged on the movable platform 20.

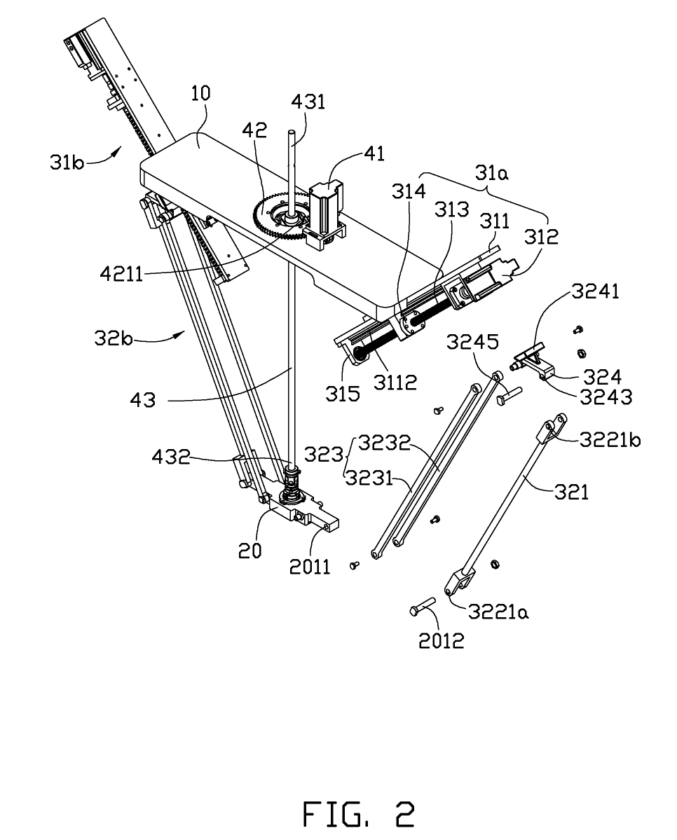

As shown in FIGS. 1 and 2, the linear driving mechanism 31a includes a connection plate 311, a first actuator 312, a threaded bar 313 driven by the first actuator 312, and a threaded base 314 coupled to and slidable along the threaded bar 313 via the engagement thereof, and a support base 315 rotatably supporting the threaded bar 313.

The connection plate 311 is fixed to a side of the base 10 by a fixing means, for example, such as welding and threaded connection. The first actuator 312 and the support base 315 are mounted on opposite ends of the connection plate 311. The threaded bar 313 angles downward with respect to base 10. The connection plate 311 forms a slide guide 3112 parallel to the threaded bar 313, and the threaded base 314 defines a slide groove (not labeled) corresponding to the slide guide 3112. When the threaded bar 313 is rotated by the actuator 312, the threaded base 314 is moved along the threaded bar 313 via the engagement thereof. It should be pointed out that the linear driving mechanism 31a can alternatively employ a belt transmission or a pneumatically driven system which can also realize the translation of the threaded base 314.

The parallel four-bar linkage 32a includes a first link bar 321, a second link bar 323, and a third link bar 324. The first and second link bars 321, 323 are substantially parallel to each other, and opposite ends of the third link bar 324 are pivotally connected to the first and second link bars 321, 323, respectively. The ends of the first and second link bars 321, 323 away from the third link bar 324 are pivotally connected to the movable platform 20, so that the first, second, and third link bars 321, 323, 324, and the movable platform 20 cooperatively form a parallel four-bar linkage 32a. The third link bar 324 further includes a connection portion 3241 to connect to the threaded base 314, which can accordingly swing the parallel four-bar linkage 32a on a plane.

The ends of the first link bar 321 are substantially forked and define two pivot holes 3221a and 3221b. The third link bar 324 and the movable platform 20 correspondingly define two pivot holes 3243 and 2011, respectively. A pin 2012 passes through the pivot holes 3221a and 2011 to pivotally connect the first link bar 321 and the movable platform 20. A pin 3245 passes through the pivot holes 3221b and 3243 to pivotally connect the first bar 321 and the third link bar 324.

The second link bar 323 includes two parallel bars 3231, 3232 to enhance the carrying capacity and stability of the parallel four-bar linkage 32a. The plane on which the bars 3231, 3232 are arranged is perpendicular to that on which the first and second kinematic chains 30a, 30b are positioned. The bars 3231, 3232 are positioned on opposite sides of the movable platform 20 and pivotally connected to the third link bar 324 and the movable platform 20.

The second kinematic chain 30b is similar to the first kinematic chain 30a, and is also provided with a linear driving mechanism 31b and another parallel four-bar linkage 32b. The first and the second kinematic chains 30a, 30b cooperatively translate the movable platform 20 in the same plane.

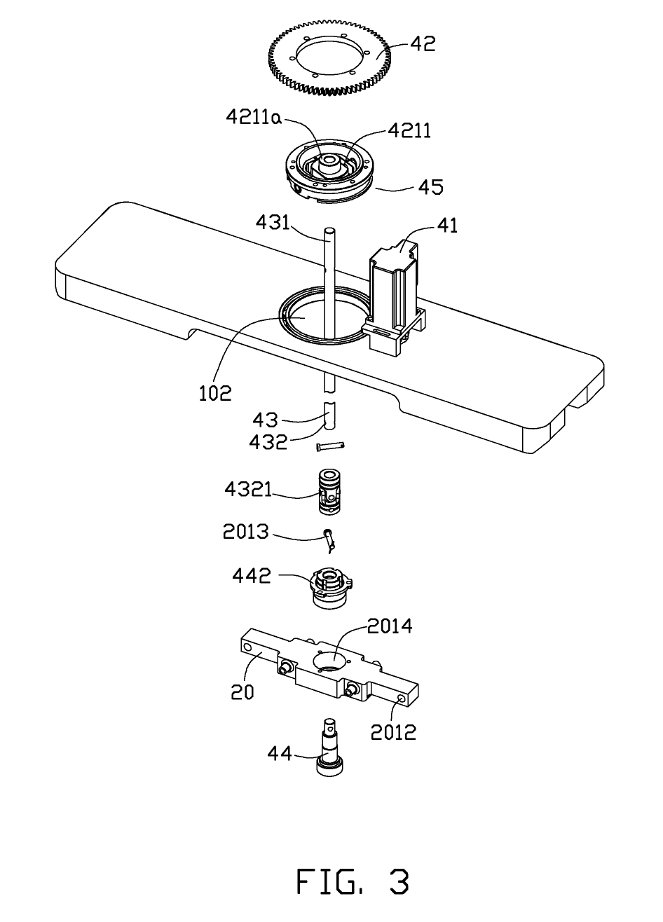

Referring also to FIG. 3, the third kinematic chain 40 includes a second actuator 41, a gear 42 driven by the second actuator 41, and a rotation bar 43 rotating together with the gear 42, an output bar 44 rotatably connected to the movable platform 20 and pivotally connected to the rotation bar 43, and a connection assembly 45 connecting the gear 42 and the rotation bar 45.

The rotation bar 43 and the output bar 44 are positioned between the first and the second kinematic chains 30a, 30b. The free end of the output bar 44 extends out of the movable platform 20 with the end effector mounted thereon.

The base 10 is substantially a plate with an assembly hole 102 therein to receive the rotation bar 43. The second actuator 41 is mounted on the top of the base 10 and adjacent to the assembly hole 102.

The rotation bar 43 includes an input end 431 and an output end 432 with a hook joint 4321 connected to the output bar 44. The input end 431 passes through the assembly hole 102 and the gear 42, and extends out of the base 10. The output bar 44 is connected to hook joint 4321 via a pin 2013 to pivotally connect to the rotation bar 43.

The rotation bar 43 rotates together with the gear 42, swings together with the movable platform 20, and slides along the rotation bar 43 via the connection assembly 45. The connection assembly 45 may include a hook joint 4211 connecting the gear 42 and the rotation bar 43, and a key connecting the upper potion 4211a of the hook joint 4211 and the rotation bar 43.

The output bar 44 is a stepped shaft, and the movable platform 20 defines a stepped hole 2014. The output bar 44 passes through the stepped hole 2014 and is rotatably supported by a roll bearing assembly 442 mounted in the stepped hole 2014, such that the output bar 44 can rotate relative to the movable platform 20, and the output bar 44 can translate together with the movable platform 20 and rotate together with the rotation bar 43, so that the end effector mounted on the distal end of the rotation bar 44 has three degrees of freedom.

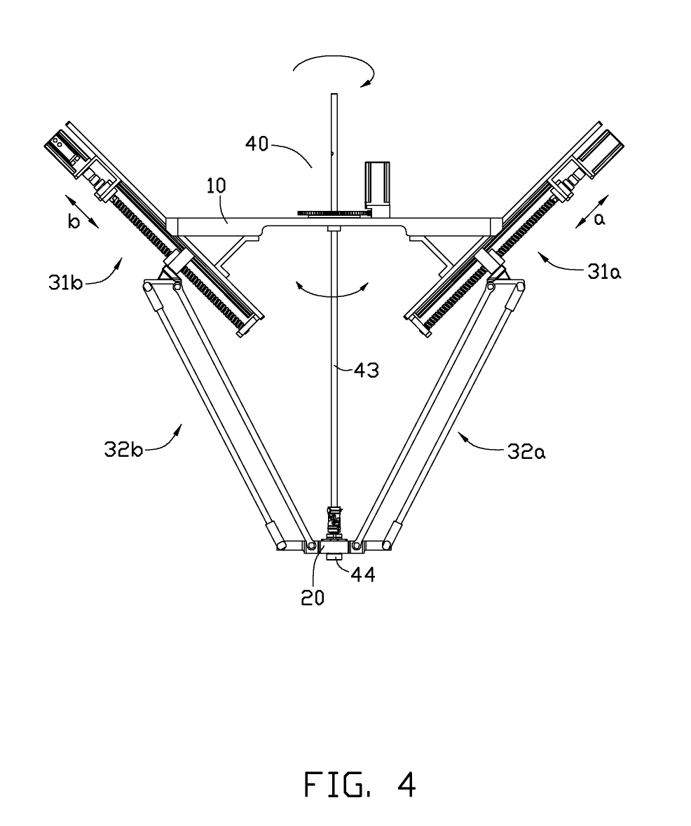

Referring also to FIG. 4, during operation, for example, when the first kinematic chains 30a drive the movable platform 20 toward the base 10, and the second kinematic chain 30b retains the current position, the movable platform 20 translates to the right side and retains a horizontal plane via the parallel four-bar linkages 32a, 32b. The movable platform 20 can be positioned in a predetermined position via the cooperative movements of the first and the second kinematic chains 30a, 30b. The third kinematic chain 40 swings together with the movable platform 20 and rotates the end effector on the distal end of the output bar 44 to a predetermined position.

In other embodiments, the first and the second kinematic chains 30a, 30b may be asymmetric and differ in construction.

Finally, while various embodiments have been described and illustrated, the disclosure is not to be construed as limited thereto. Various modifications can be made to the embodiments by those skilled in the art without departing from the true spirit and scope of the disclosure as defined by the appended claims.

What is claimed is:

1. A parallel robot, comprising:
a base;
a movable platform;
a first kinematic chain and a second kinematic chain respectively connected to the fixed platform and the movable platform and moving on the same plane, wherein each of the first and second kinematic chains comprises:
a linear driving mechanism mounted on the base; and
a parallel four-bar linkage driven by the linear driving mechanism and hinged on the movable platform.

2. The parallel robot of claim 1, wherein the first and the second kinematic chains are substantially bilaterally symmetric.

3. The parallel robot of claim 1, wherein each of the parallel four-bar linkages comprises a first link bar and a second link bar parallel to the first link bar, and the first and second link bars are pivotally connected to the movable platform and the linear driving mechanism, respectively.

4. The parallel robot of claim 3, wherein each of the parallel four-bar linkages further comprises a third link bar connected to the linear driving mechanism with opposite ends pivotally connected to the first and second link bars, respectively.

5. The parallel robot of claim 4, wherein each of the second link bars comprises two parallel bars positioned on a plane perpendicular to the plane in which the first and second kinematic chains are positioned.

6. The parallel robot of claim 1, wherein each of the linear driving mechanism comprises an actuator, a threaded bar driven by the actuator, a threaded base threaded on and capable of moving along the threaded bar, and a support base rotatably supporting the threaded bar.

7. The parallel robot of claim 6, wherein each of the linear driving mechanism further comprises a connecting plate fixed to a side of the base on opposite ends of which the actuator and the support base are mounted, and the threaded bar angling downward with respect to the base.

8. The parallel robot of claim 7, wherein the connection plate forms a slide guide parallel to the threaded bar, and the threaded base defines a slide groove corresponding to the slide guide.

9. The parallel robot of claim 1, further comprising a third kinematic chain comprising an actuator, a gear driven by the actuator, and a rotation bar rotating together with the gear, an output bar rotatably connected to the movable platform and pivotally connected to the rotation bar, and a connection assembly connecting the gear and the rotation bar to allow rotation and sliding of the rotation bar along the axis thereof.

10. The parallel robot of claim 9, wherein the connection assembly comprises a hook joint connecting the gear and the rotation bar, and a key connecting the hook joint and the rotation bar.

11. The parallel robot of claim 10, wherein the rotation bar comprises and input end passing through the assembly hole and the gear, and an output end with a hook joint connecting to the output bar.

12. The parallel robot of claim 10, wherein the output bar is a stepped shaft, the movable platform defines a stepped hole, and the output bar passes through the stepped hole and is rotatably supported by a roll bearing assembly mounted in the stepped hole.

13. A parallel robot, comprising:
a base;
a movable platform;
a first kinematic chain and a second kinematic chain respectively connected to the fixed platform and the movable platform and moving on the same plane, wherein each of the first and second kinematic chains comprises:
a linear driving mechanism mounted on the base; and
a parallel four-bar linkage driven by the linear driving mechanism and hinged on the movable platform; and
a third kinematic chain for rotating an end effector mounted at a distal end thereof, wherein the third kinematic chain moves together with the movable platform driven by the first and second kinematic chains and rotates the end effector relative to the movable platform, thereby allowing the end effector to realize three degrees of freedom.

14. The parallel robot of claim 13, wherein the first and the second kinematic chains are substantially bilaterally symmetric.

15. The parallel robot of claim 14, wherein each of the parallel four-bar linkage comprises a first link bar and a second link bar pivotally connected to the movable platform and the linear driving mechanism, respectively, and a third link bar connected to the linear driving mechanism with opposite ends pivotally connected to the first and second link bars, respectively.

16. The parallel robot of claim 13, wherein the third kinematic chain comprises an actuator, a gear driven by the actuator, and a rotation bar rotating together with the gear, an output bar rotatably connected to the movable platform and pivotally connected to the rotation bar, and a connection assembly connecting the gear and the rotation bar.

17. The parallel robot of claim 16, wherein the connection assembly comprises a hook joint connecting the gear and the rotation bar, and a key connecting the hook joint and the rotation bar.

18. The parallel robot of claim 16, wherein the rotation bar includes and input end passing through the assembly hole and the gear, and an output end with a hook joint connecting to the output bar.
